(19) United States
(12) Patent Application Publication
(10) Pub. No.: US 2007/0294367 A1
(43) Pub. Date: Dec. 20, 2007

(54) SYSTEM AND METHOD FOR DELIVERING DATA

(75) Inventor: Kazuhito Akiyama, Tokyo (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/745,852

(22) Filed: May 8, 2007

(30) Foreign Application Priority Data
Jun. 16, 2006 (JP) 2006166832

(51) Int. Cl. G06F 15/16

(52) U.S. Cl. 709/217

(57) ABSTRACT

The present invention processes hierarchical data into a structure suitable for display on compact terminal devices having different display and performance capabilities. A data server includes a data storage section configured to store, by category, a plurality of records constituting data to be delivered. The server also a determining section that can determine whether the number of records included in each category exceeds a maximum allowable number for a requesting terminal device, a categorizing section that can further categorize a plurality of records included in an oversized category into multiple subcategories, each of which has no more than the maximum allowable number of records, and a delivering section for delivering records to the requesting terminal device categorized into sets containing no more than the maximum allowable number of records.

### FIELD OF THE INVENTION

The present invention relates to delivery of data to compact terminal devices, and more specifically, to delivery of data to such devices after it is categorized.

### BACKGROUND ART

Techniques for delivering data stored in a server to a compact terminal device such as a personal digital assistant (PDA) or mobile phone and for synchronizing the data between the server and the terminal device are known. Since the amount of data intended to be delivered by such techniques may be relatively large at times, the data delivered is often categorized for ease of use. For example, when product data is categorized by initials of product names or manufacturer's names, the data in each category can be listed on the small screen of the terminal device, which helps the user find desired data.

Japanese Published Patent Application No. 2004-240179 discloses a music search terminal in which a desired song can easily be searched for by applying such categorization to songs for karaoke. Japanese Published Patent Application No. 2004-177441 discloses a remote controller for karaoke in which search conditions set in selecting a karaoke song are stored so that the stored search conditions can be accessed again, thereby facilitating searching and displaying search results.

However, the performance capabilities of compact terminal devices, such as throughput of a CPU, storage capacity, functions of installed application programs, and size of a display screen, sometimes varies from one device to another. In this case, if the same data is delivered to all terminal devices, data searching would sometimes be difficult. For example, while data in one category can be listed on the screen of one terminal device, the data cannot be displayed on other terminal devices. Moreover, high-volume data in one category may create an excessive load on the CPU of a certain terminal device, resulting in an increase in processing time.

Two solutions have been considered for a server and terminal devices, respectively. One known solution is a method in which a server categorizes data to be delivered in advance so that the data has a structure suitable for a terminal device with the lowest performance capabilities. However, with such a method, terminal devices with higher performance capabilities cannot make full use of their capabilties. Moreover, when a new terminal device with even lower performance capabilities is introduced, categorization of the data must be changed. Furthermore, even for terminal devices with the same performance capabilities, this method cannot provide a function of changing the method of categorization according to the preference of the user.

The other known solution is a method in which each terminal device restricts search in accordance with its performance capabilities. For example, when a terminal device cannot display a complete list of records in a category selected by the user, the terminal device searches for only a displayable number of records, and searches for the other records in the same category next time. When a terminal device cannot display a complete list of records in a selected category, the terminal device requests the user to give additional search condition so as to decrease the number of records. However, to achieve such restrictions, complicated development processes would be required which may be different for each terminal device. Moreover, to achieve such restrictions, the searching process would become complicated, rather increasing processing time.

### SUMMARY OF THE INVENTION

Accordingly, it is an object of the present invention to provide a system, method, and program product for solving the above problems

To solve the above problems, the invention provides a system including a server. The server includes a data storage section for storing, by categories, a plurality of records constituting data to be delivered. The server also includes a determining section for determining whether the number of records included in each category exceeds a maximum number specified for a destination terminal device and a categorizing section that, when a category contains more than the specified maximum number, to break the category into a plurality of subcategories, each of which contains fewer than the predetermined maximum number of records. A server delivering section delivers a plurality of records including records categorized into the subcategories to the terminal device.

The invention allows hierarchical data to be processed into a structure suitable for each different compact terminal device.

### BRIEF DESCRIPTION OF THE DRAWINGS

FIG. 1 shows a general arrangement of an information processing system according to the present invention.

FIG. 2 shows an example of a data structure of a data storage section in the information processing system shown in FIG. 1.

FIG. 3 shows a first example of a display in the information processing system shown in FIG. 1.

FIG. 4 shows a functional structure of a server in the information processing system shown in FIG. 1.

FIG. 5 shows an example of a data structure of a cache in the server shown in FIG. 4.

FIG. 6 shows a functional structure of a terminal device in the information processing system shown in FIG. 1.

FIG. 7 shows an example of a data structure of a maximum number storage section in the terminal device shown in FIG. 6.

FIG. 8 shows a second example of the display in the information processing system shown in FIG. 1.

FIG. 9 shows a flowchart of processing by which the server delivers data in response to a delivery request.

FIG. 10 shows the details of particular steps in the data delivery processing shown in FIG. 9.

FIG. 11 shows a flowchart of processing by which the terminal device sends a delivery request.

FIG. 12 shows an exemplary hardware configuration of an information processing system serving as the server or the terminal device.

### DETAILED DESCRIPTION

While the present invention will be described below with reference to a preferred embodiment of the invention (hereinafter referred to as embodiment), it is to be understood that the following embodiment does not limit the scope of the invention as described in the appended claims and that all the combinations of features described in the embodiment are not always essential to solutions provided by the invention.

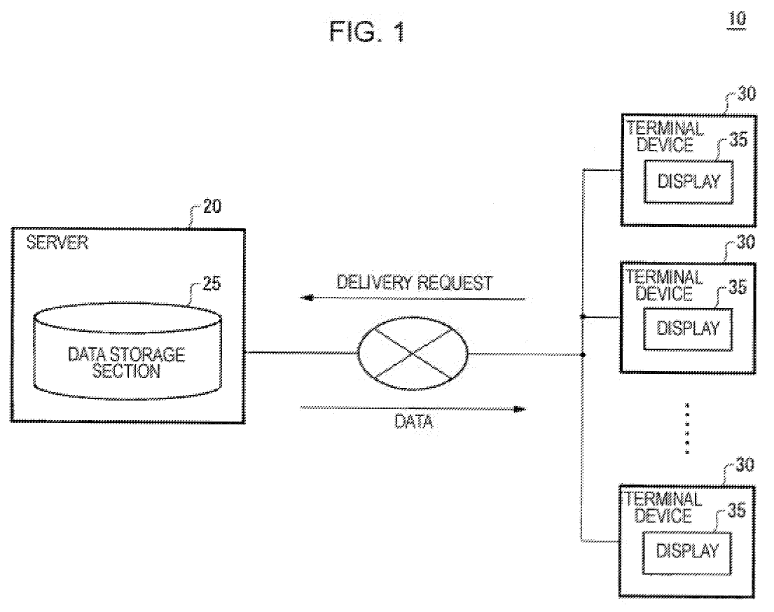

FIG. 1 shows a general arrangement of an information processing system 10. The information processing system 10 includes a server 20 and a plurality of terminal devices 30 which receive data delivered from the server 20. The server 20 includes a data storage section 25 which stores data to be delivered. The server 20 reads data from the data storage section 25 in response to a data delivery request from any of the terminal devices 30, and delivers the data to the requesting terminal device 30. Each of the terminal devices 30 has a display 35, on which the delivered data is displayed. When the terminal device 30 is a compact device such as a PDA or a cellular phone, the display 35 often does not have a sufficiently wide display area. If such a terminal device 30 receives a large volume of data, the terminal device 30 cannot list all of the data on its display, so that the user may have trouble finding desired data.

Therefore, the server 20 according to the embodiment categorizes data to be delivered in advance, and stores the categorizations in the data storage section 25. Moreover, upon reception of a delivery request, the server 20 dynamically categorizes the data in a category into subcategories to provide a data structure suited to the destination terminal device 30. This increases the convenience of the user of the terminal device 30 without imposing any load on the terminal device 30. Next, the embodiment will be described in which categorized product information is delivered from the server 20 to the terminal device 30.

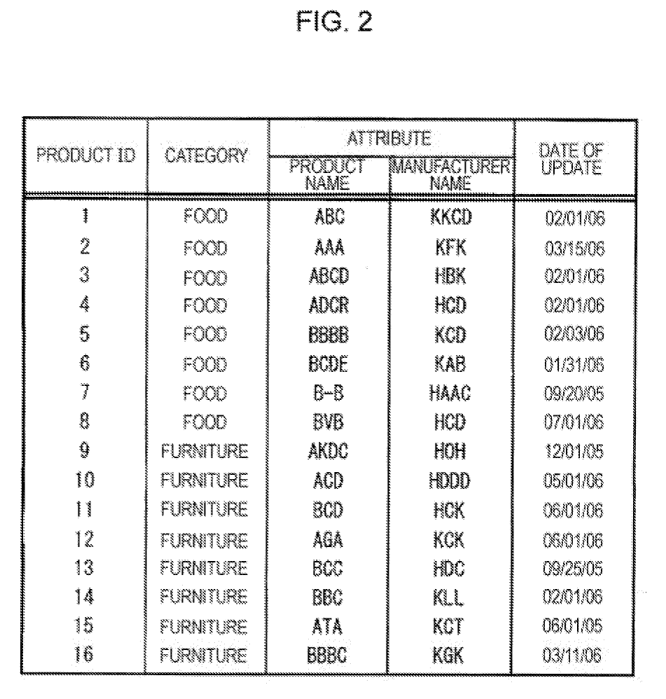

FIG. 2 shows an example of a data structure of the data storage section 25. The data storage section 25 stores a plurality of records that constitutes data to be delivered for each category. In the example of FIG. 2, the data storage section 25 stores product IDs in association with the respective categories of the products, and also stores attributes (product names and manufacturer names) of the products as records. The data storage section 25 also stores last dates of update of the respective records. Specifically, products 1 to 8 are categorized into a food category, and products 9 to 16 are categorized into a furniture category. For example, the product name of product 1 is ABC, the manufacturer name of product 1 is KKCD, and the last date of update of the record is Feb. 1, 2006. A category or subcategory means a class into which a record is categorized by the server 20 according to the embodiment or an administrator, and indicates a unit of display on the terminal device 30. The unit of display may be either one screen or a predetermined number of screens of the display section 35. For example, records in the same category are listed on one screen of the display section 35 as much as possible.

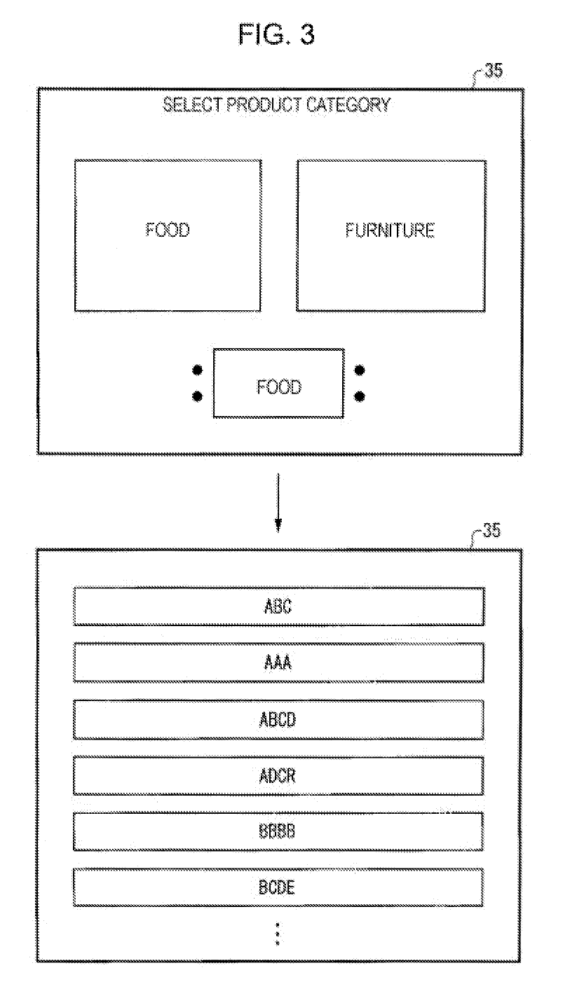

FIG. 3 shows a first example of the display 35. The display 35 displays a category selection screen for a plurality of categories of delivered records to allow the user to specify a category. Referring to FIG. 3, a case in which each category is not categorized into subcategories will be described. The example of FIG. 3 corresponds to the data of FIG. 2, in which the display 35 displays a food category and a furniture category. When a food category is selected on the selection screen by the user, the display 35 displays a list of names of products categorized into the food category. However, since the display area of the display 35 illustrated is small, the display section 35 cannot display all the records in the food category. This requires scrolling the screen or increases a process load on the terminal device 30, resulting in an increase in processing time, which makes it difficult for the user to find a desired record.

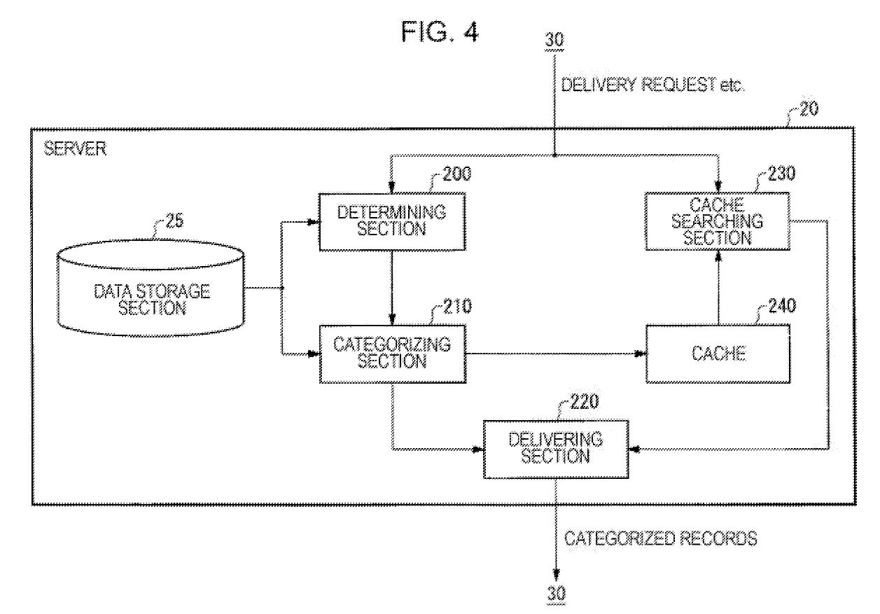

FIG. 4 shows a functional configuration of the server 20. The server 20 includes the data storage section 25, a determining section 200, a categorizing section 210, a delivering section 220, a cache searching section 230, and a cache 240. The determining section 200 receives the maximum number of records that can be included in one category and a categorizing method for categorizing records into subcategories when the records included in one category exceeds the maximum number specified for the terminal device 30 in association with a data delivery request. The maximum number may either be specified by the user of the destination terminal device 30 (source of a delivery request) or be predetermined according to the throughput of the terminal device 30 and the amount of information that the display 35 can display. Upon receiving the delivery request, the determining section 200 scans the categories in the data storage section 25 to determine whether the number of records included in each category exceeds the specified maximum number.

The categorizing section 210 may further categorize a plurality of records included in a category in which the number of records exceeds the maximum allowable number into a plurality of subcategories using the received categorizing method, so that the number of records included in each subcategory becomes smaller than the maximum number. The categorizing section 210 may further categorize a plurality of records included in a subcategory into a plurality of further subcategories if the number of the records included in a further subcategory does not become equal to or smaller than the maximum allowable number.

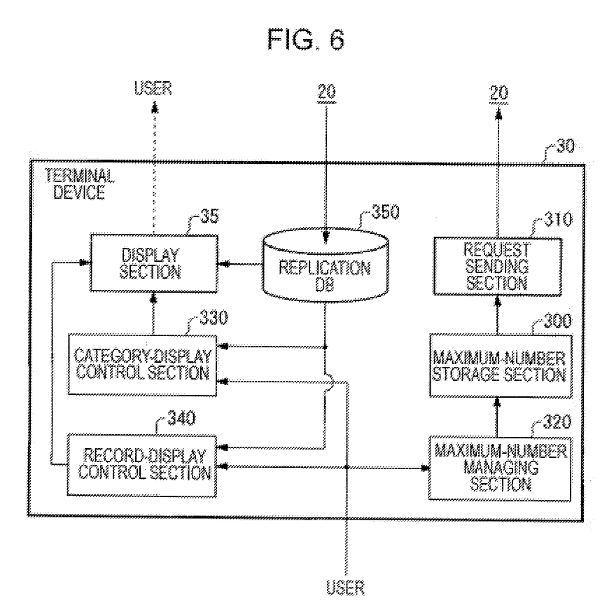

The delivering section 220 sends a plurality of records that include records categorized into a plurality of subcategories to the terminal device 30. When the server 20 allows the terminal device 30 to reproduce records stored in the data storage section 25, the delivering section 220 obtains records categorized into subcategories from the categorizing section 210 and delivers them, and obtains all other records that are not categorized into subcategories from the data storage section 25 and delivers them. The delivering section 220 may deliver the maximum allowable number and the categorizing method that are to be stored in a maximum number storage section 300 (FIG. 6) of a terminal device 30 to each terminal device 30 so as to set the initial value of the maximum number before the first delivery of the records.

Every time the records are categorized into subcategories by the categorizing section 210, the cache 240 stores information indicating a category structure after categorization in association with a set of the maximum number and the categorizing method received. When a maximum number and a categorizing method are specified by a terminal device 30, the cache searching section 230 searches the cache 240 for the specified values. If the specified values are not found in cache 240, the delivering section 220 delivers records including those categorized into the subcategories by the categorizing section 210 to the terminal device 30, as described above. On the other hand, if the specified values are found in the cache 240, the delivering section 220 reads a structure corresponding to the specified values and delivers records categorized by the structure to the terminal device 30. Thus, a turnaround time from reception of a delivery request to delivery can be reduced.

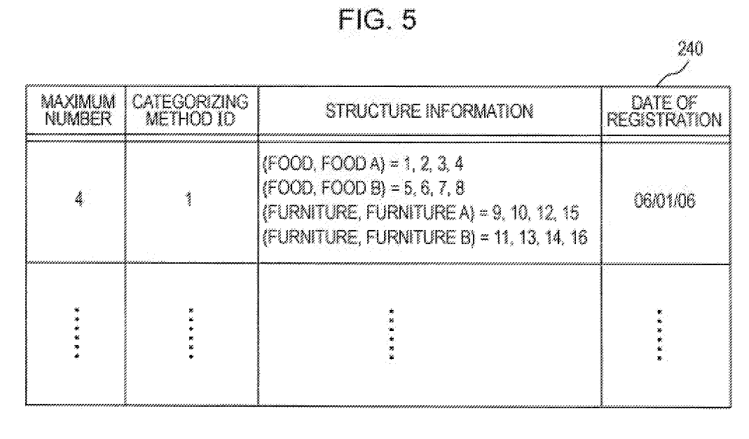

FIG. 5 shows an example of a data structure of the cache 240. The cache 240 stores information indicating the structure of categories categorized by a categorizing method to limit the number of records in each category to a value equal to or less than a maximum allowable number, in association with a set of specified values for the maximum number and the categorizing method ID. The example of FIG. 5 shows a structure in which the records in the food category and the furniture category are categorized by the initials of the product names, respectively. That is, the records in the food category are categorized into a food-A subcategory and a food-B subcategory depending on whether the initial of the product name is A or B. The food-A subcategory includes the records of products 1 to 4. The food-B subcategory includes the records of products 5 to 8. The records in the furniture category are also categorized into a furniture-A subcategory and a furniture-B subcategory depending on whether the initial of the product name is A or B. The furniture-A subcategory includes the records of products 9, 10, 12, and 15. The furniture-B subcategory includes the records of products 11, 13, 14, and 16. Since the structure of categorization is stored in association with the maximum number and the categorizing method ID, the cache searching section 230 can quickly determine the structure of record categorization in response to a similar delivery request. Although FIG. 5 shows that the cache 240 stores categorizing method IDs in place of categorizing methods themselves, information to be stored may be either categorizing methods themselves or other information from which a categorizing method can be identified. Alternatively, the cache 240 may store the date at which the set of the maximum number and the categorizing method and structure information were registered in the cache 240 in association therewith. This enables appropriate determination whether each entry is the latest in a differential delivery, which will be described later.

FIG. 6 shows a functional configuration of the terminal device 30. Referring to FIG. 6, a typical terminal device 30 will be described. Each of the other terminal devices may be substantially the same as the terminal device 30 shown in FIG. 6 except that a user is different and a maximum number stored in the maximum number storage section 300 is different. The terminal device 30 includes the display section 35, the maximum number storage section 300, a request transmitting section 310, a maximum number managing section 320, a category display control section 330, a record display control section 340, and a replication database 350. The maximum number storage section 300 stores the maximum number of records that can be included in one category, which is predetermined according to the throughput of the terminal device 30 and the amount of information that can be displayed on the display 35. The maximum number may be, for example, the number of lines of character strings that can be displayed on the display 35 or the number of records estimated to be displayable in a predetermined time (e.g., one or two seconds). The maximum number storage section 300 may further store a method for categorizing the records into subcategories when the number of records included in one category exceeds the maximum number. The categorizing method may be described with predetermined commands (e.g., sequential query language (SQL)) that can be read by a database management system.

The request sending section 310 sends the maximum number and the categorizing method stored in the maximum number storage section 300 to the server 20 in association with a data delivery request. The maximum number managing section 320 receives the initial values of the maximum number and the categorizing method delivered from the delivering section 220 prior to the first delivery of records by the server 20. The delivered maximum number and categorizing method are stored in the maximum number storage section 300. The maximum number managing section 320 changes the stored maximum number and categorizing method in response to a subsequent instruction from the user. Since the maximum number and the categorizing method can be set by the user in this way, the user of the terminal device 30 can customize the category selection screen according to the characteristics (performance and screen display area) of the device and/or the preference of the user.

The replication database 350 stores records delivered from the delivering section 220 in response to a delivery request. The display section 35 displays a category selection screen for a plurality of categories of the delivered records to allow the user to specify a category. The category display control section 330 determines whether the category specified by the user includes subcategories. If the specified category includes subcategories, the category display control section 330 causes the display section 35 to display a subcategory selection screen for a plurality of subcategories included in the specified category to allow the user to specify a subcategory.

If a subcategory specified by the user further includes its own subcategories, the category display control section 330 causes the display section 35 to display a subcategory selection screen for a plurality of subcategories included in the specified subcategory to allow the user to specify a second level subcategory. If the category specified by the user includes no subcategory or if a subcategory including no second level subcategories is specified, the category display control section 330 causes the display section 35 to display records in the specified category or subcategory.

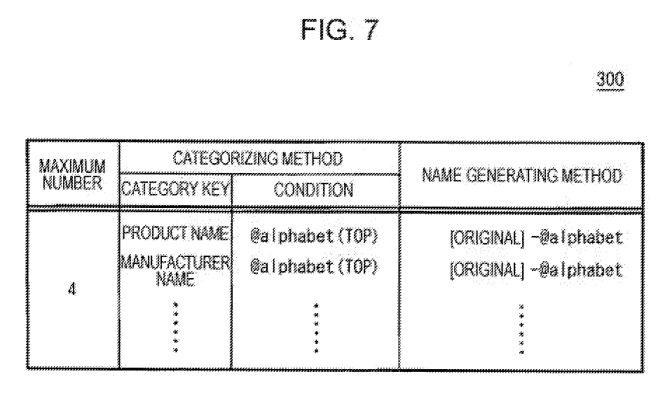

FIG. 7 shows an example of a data structure for use in the maximum number storage section 300. The maximum number storage section 300 stores a method for categorizing records included in one category into subcategories when the number of the records included in one category exceeds the maximum allowable number for a single category. In the example of FIG. 7, the maximum number storage section 300 stores 4 as the maximum number, and stores, as a categorizing method, a set of a record attribute (category key) used as a categorization factor and a condition that the records to be categorized into subcategories should satisfy for the attribute. The example on the first line shows that the attribute uses as the categorization factor is a product name, and the condition that the records to be categorized into the respective subcategories should satisfy for the product names is that the initials of the product names are the same in each subcategory.

As shown in the example on the second line, the maximum number storage section 300 requires that a manufacturer name be used as the attribute for the categorization factor, and further requires that each subcategory should contain only records satisfying the same requirement in each subcategory. Thus, the maximum number storage section 300 may store a plurality of categorizing methods in association with one maximum number. In this case, the request sending section 310 categorizes the records in the category into a plurality of subcategories by the first categorizing method shown on the first line, and when the number of records in a certain subcategory is still greater than the maximum number, the request sending section 310 further categorizes the records in that subcategory by employing the second categorizing method shown on the second line. By specifying a number of categorizing methods in this manner, category structure can be flexibly changed even if the data storage section 25 is updated to increase the number of records.

In place of the method described with reference to FIG. 7, the maximum number storage section 300 may store, for each subcategory, a condition that the records to be included in that subcategory should satisfy for the attribute. Specifically, the maximum number storage section 300 may require that each subcategory contain only records identified by a product name beginning with a particular letter of the alphabet. This approach would support 26 subcategories. A specific embodiment for specifying a categorizing method is not limited to the above, and any existing technique for grouping records in a database can be used. Thus, by allowing the user to specify a categorizing method, any categorization desired by the user can be achieved; for example, records having the same initial of product names can be categorized into the same subcategory, records having the same leading two characters can be categorized into the same subcategory, or records having the same initial of manufacturer names can be categorized into the same subcategory.

Furthermore, the maximum number storage section 300 may store a name generating method for generating a name of each subcategory from a name of a category to be categorized. In this case, the categorizing section 210 generates the respective names of categorized subcategories by the name generating method, and the category display control section 330 causes the display section 35 to display the generated names of subcategories as a subcategory selection screen. By appropriately setting the name generating method, a selection screen after categorization can be determined in advance.

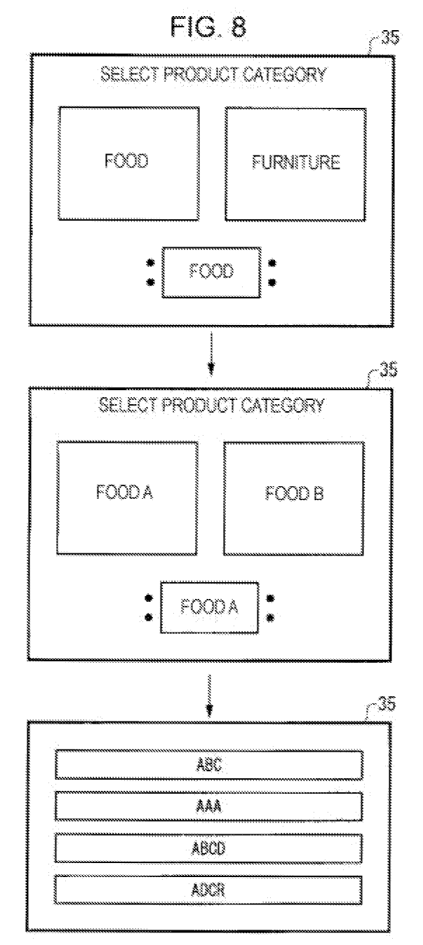

FIG. 8 shows a second display example of the display 35. FIG. 8 shows a display example based on the data after the records of food shown in FIG. 2 have been categorized by the initials. The display 35 first displays a category selection screen showing a plurality of categories of delivered records to allow the user to specify a category. Here, a food category and a furniture category are displayed. When the food category, which includes a food-A subcategory and a food-B subcategory, is selected, the category display control section 330 displays a screen for selecting the food-A subcategory or the food-B subcategory. Here, the food-A subcategory includes the records of products having the initial A among the records in the food category, and the food-B subcategory includes the records of products having the initial B among the records in the food category.

When the food-A subcategory, which includes no subcategory, is specified by the user, the record display control section 340 causes the display 35 to display a plurality of records included in the food-A subcategory. As a result, product ABC, product AAA, product ABCD, and product ADCR are displayed. As seen from the comparison of FIG. 8 with FIG. 3, the display section 35 can display a list of product names in a subcategory by categorizing a category into subcategories. Thus, the user can accurately find a desired record by a combination of operations specifying a category.

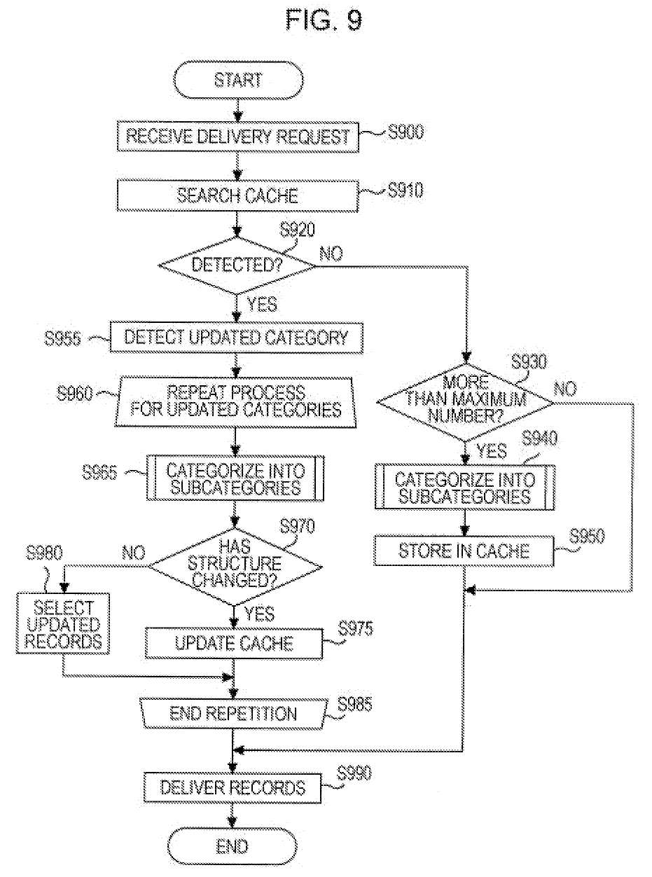

FIG. 9 shows a flowchart of processing by which the server 20 delivers data in response to a delivery request. Upon receiving a data delivery request as well as a maximum number and a categorizing method (S900), the cache searching section 230 searches the cache 240 using the maximum number and the categorizing method (S910) as the search conditions. When a set of the maximum number and categorizing method is not detected (S920: NO), the determining section 200 determines whether the number of records included in each category stored in the data storage section 25 exceeds the maximum allowable number (S930).

When step S930 shows that the numbers of the records in all the categories do not exceed the maximum number, the delivering section 220 reads the records from the data storage section 25 and delivers them to a requesting terminal device 30 (S990). If there is a category in which the number of records exceeds the maximum number (S930: YES), the categorizing section 210 categorizes the records included in that category into a plurality of subcategories using the specified categorizing method (S940). The cache 240 stores information indicating the structure of the categorized category in association with a set of the maximum number and the categorizing method (S950). The delivering section 220 delivers a plurality of records including the records categorized into the subcategories to the terminal device 30 (S990).

Even where the maximum number and the categorizing method received are found to be specified in the cache 240 (S920: YES), the determining section 200 can still detect a category including a record that was updated after the maximum number and the categorizing method were stored in the cache 240 (S955). This detecting process is achieved by comparing the date of update of each record, shown in FIG. 2, and the date of registration of each cache entry, shown in FIG. 5. The determining section 200 repeats the following process for each category including the updated record (S960).

First, the categorizing section 210 further categorizes the records in each category into a plurality of subcategories (S965) so as to limit the number of records included in each category to a value equal to or smaller than the maximum number. The categorizing section 210 compares the structure of the category stored in the cache 240 in association with the set of the maximum number and the categorizing method with the structure of the category generated by the new categorization (S970). If the structure of the category has changed from that in the cache 240 (S970: YES), the cache 240 updates the structure stored in association with the set of the maximum number and the maximum number to the structure of the category generated by new categorization (S975).

On the other hand, if the structure of the category has not changed (S970: NO), the delivering section 220 selects only updated records as records to be delivered (S980). The server 20 repeats the above process for each category that includes updated records (S985). Then, the delivering section 220 delivers the records selected in S980 and the records in the category that has changed in structure to the terminal device 30. This allows only a difference or delta in the update to be delivered appropriately, thus reducing communication traffic or process loads on the server 20 and the terminal device 30.

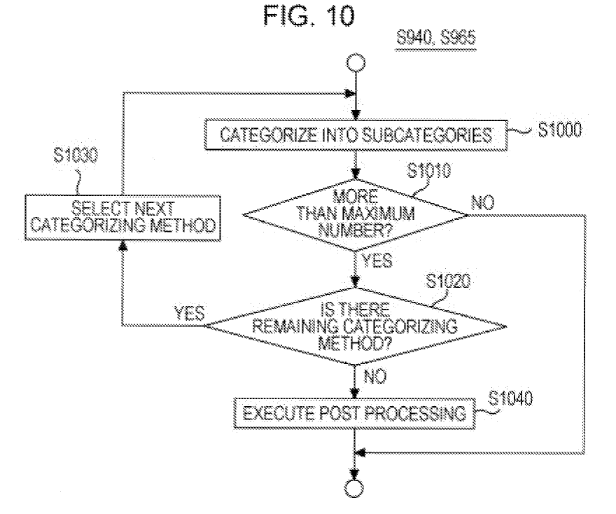

FIG. 10 shows the details of the processes in S940 and S965. The categorizing section 210 categorizes records in a category that exceeds the maximum allowable number into multiple subcategories using the specified categorizing method (S1000). Specifically, when the categorizing method includes an attribute and a condition that the attribute should satisfy, the categorizing section 210 may categorize an oversized set of records into several subcategories, depending on whether the attribute specified by the categorizing method satisfies the condition specified by the categorizing method. The categorizing section 210 then determines whether the number of records in any of the subcategories after categorization exceeds the maximum number (S1010).

If the number of records in a subcategory still exceeds the maximum number (S1010: YES), the categorizing section 210 determines whether there remains a categorizing method that has not been used among the categorizing methods specified in association with the delivery request (S1020). If there remains an unused categorizing method (S1020: YES), the categorizing section 210 selects the next unused categorizing method (S1030). The categorizing section 210 then returns to S1000, where it further categorizes the records in the category exceeding the maximum number into subcategories by the selected categorizing method. For example, by the categorizing method of FIG. 7, the categorizing section 210 first categorizes the records by the initials of the product names. If the number of the records in any resulting category still exceeds the maximum number, the categorizing section 210 categorizes the records in that category by the initials of the manufacturer names. If the numbers of the records in all the subcategories are equal to or smaller than the maximum number (S1010: NO), the server 20 terminates the process shown in FIG. 10 without performing any further subcategorization.

On the other hand, if there is a category that still has more than the maximum number of allowable records (S1010: YES), after all specified categorizing methods have been applied (S1020: YES), the categorizing section 210 executes a predetermined post processing (S1040). For example, the categorizing section 210 may further categorize the records in a category exceeding the maximum number into subcategories by a standard categorizing method which is established for use in those situations where no categorizing method has been specified. The categorizing section 210 may notify the terminal device 30 that further categorization is necessary. Alternatively, the categorizing section 210 may output delivery records to the delivering section 220 without executing any post processing even though the delivery includes a category in which the number of records exceeds the maximum number.

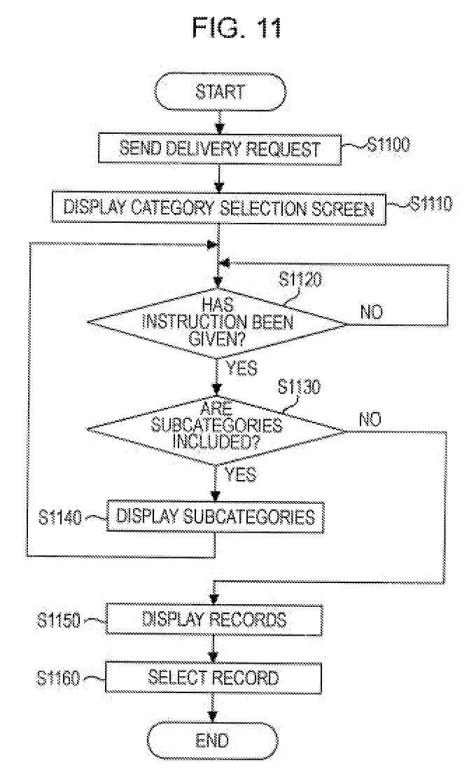

FIG. 11 shows a flowchart of the process followed by a terminal device 30 when it sends a delivery request. The request sending section 310 sends a maximum number and a categorizing method to the server 20 in association with a data delivery request (S1100). Upon receiving categorized records, the display 35 displays a category selection screen for a plurality of categories of the delivered records to allow the user to specify a category (S1110). In response to auser's instruction (S1120: YES), the category display control section 330 determines whether the specified category includes subcategories (S1130).

If subcategories are included (S1130: YES), the category display control section 330 displays a selection screen for the subcategories included in the specified category to allow the user to specify a subcategory (S1140). The terminal device 30 returns the process to S1120 so as to receive the next instruction from the user. On the other hand, if the specified category includes no subcategory or a subcategory that includes no subcategory of its own is specified (S1130: NO), the record display control section 340 causes the display 35 to display the records included in the specified category or subcategory (S1150). Then, in response to selection of a record by the user, the terminal device 30 executes additional processes, e.g., displaying detailed description of a product, executing sales and settlement processing for the product, etc. (S1160).

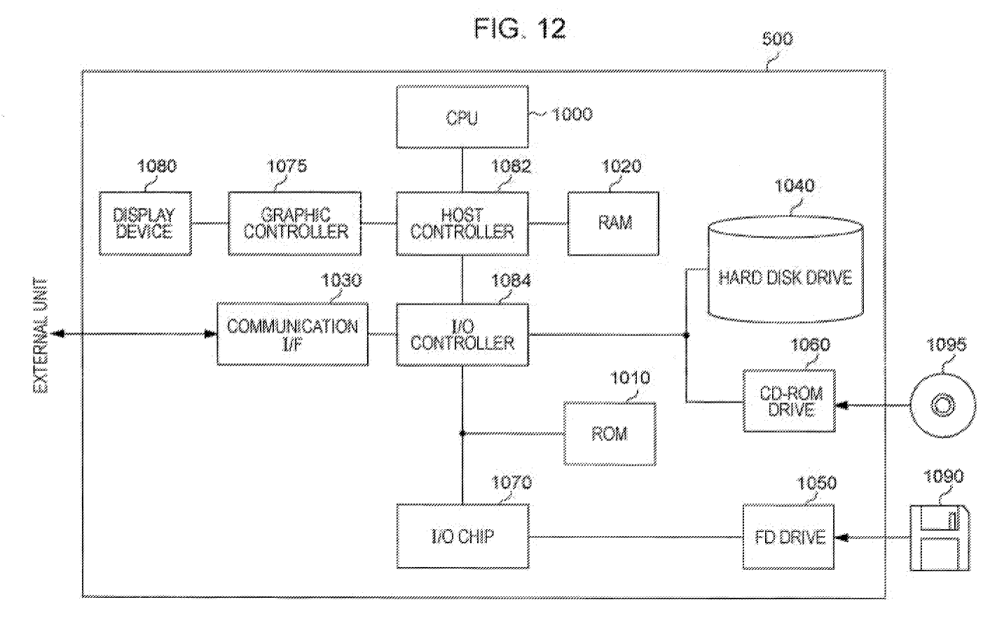

FIG. 12 shows an exemplary hardware configuration of an information processing system 500 serving as the server 20 or the terminal device 30. The information processing system 500 is provided with a CPU related part, an input/output part, and a legacy input/output part. The CPU related part includes a CPU 1000, a RAM 1020, and a graphic controller 1075, which are interconnected by a host controller 1082. The input/output part includes a communication interface 1030, a hard disk drive 1040, and a CD-ROM drive 1060, which are connected to the host controller 1082 via an input/output controller 1084. The legacy input/output part includes a ROM 1010, a flexible disk drive 1050, and an input/output chip 1070, which are connected to the input/output controller 1084.

The host controller 1082 connects the RAM 1020 to the CPU 1000 and the graphic controller 1075, which access the RAM 1020 with a high transfer rate. The CPU 1000 operates in accordance with programs stored in the ROM 1010 and the RAM 1020, and controls each element. The graphic controller 1075 acquires image data generated by the CPU 1000 or other device from a frame buffer disposed in the RAM 1020, and displays the acquired image data on a display device 1080. Alternatively, the graphic controller 1075 may include a frame buffer for storing image data generated by the CPU 1000 or other device.

The input and output controller 1084 connects the host controller 1082 to the communication interface 1030, the hard disk drive 1040, and the CD-ROM drive 1060, which are relatively high-speed input/output devices. The communication interface 1030 communicates with an external device via a network. The hard disk drive 1040 stores programs and data used by the information processing system 500. The CD-ROM drive 1060 reads a program or data from a CD-ROM 1095, and provides the program or data to the RAM 1020 or the hard disk drive 1040.

In addition, the ROM 1010, the flexible disk drive 1050, and the input/output chip 1070, which are relatively low-speed input/output devices, are connected to the input/output controller 1084. The ROM 1010 stores a boot program executed by the CPU 1000 when the information processing system 500 is started up. The flexible disk drive 1050 reads a program or data from a flexible disk 1090, and provides the program or data to the RAM 1020 or the hard disk drive 1040 via the input/output chip 1070. The input/output chip 1070 connects the flexible disk 1090, and various input/output devices via a parallel port, a serial port, a keyboard port, a mouse port, etc.

A program to be provided to the information processing system 500 is stored on the flexible disk 1090, the CD-ROM 1095, or a recording medium such as an IC card, and is then provided by a user. The program is read out from the recording medium via the input/output chip 1070 and/or the input/output controller 1084, installed in the information processing system 500, and then executed. Since the operation that the program causes the information processing system 500 to perform is the same as that of the server 20 or the terminal device 30, described with reference to FIGS. 1 to 11, the description thereof will be omitted.

The above-described program may be stored on an external recording medium. The external recording medium may be the flexible disk 1090, the CD-ROM 1095, an optical recording medium such as a DVD or PD, a magneto-optical disk such as an MD, a tape medium, or a semiconductor memory such as an IC card. Alternatively, a storage device such as a hard disk or RAM disposed in a server system connected to a dedicated communication network or the Internet may be used as a recording medium, and the program may be provided to the information processing system 500 via the network.

As has been described with reference to the embodiment, the server 20 categorizes records into subcategories, which have been categorized into categories in advance, on the basis of a specified maximum number and a categorizing method of the records, which are received in association with a delivery request from each terminal device 30, and delivers them. Thus, the terminal devices 30 can receive records categorized into a structure suitable for their respective performances, thus improving the convenience of the users. Moreover, since categorizing methods are stored in the respective terminal devices 30 even if there is no need to categorize the records at present, appropriate data can be delivered without any additional operation even if data to be delivered is updated and its volume increases. Furthermore, since the server 20 includes a cache where categorization structures are stored, the server 20 can respond quickly to a plurality of delivery requests.

While the invention has been described with reference to the preferred embodiment, the technical scope of the invention is not limited to that of the embodiment. It is to be understood by those skilled in the art that the embodiment described above can be variously changed and modified. Accordingly, it should also be understood that such changes and modifications are included in the technical scope of the invention as claimed in the attached claims.

What is claimed is:

1. A system comprising a server for delivering data to at least one terminal device, the server comprising:
a data storage section for storing, by category, a plurality of records constituting data to be delivered;
a determining section for determining whether the number of records included in each category exceeds a predetermined maximum number for a destination terminal device that has requested data;
a categorizing section configured to further categorize a plurality of records included in a category having more than the predetermined maximum number into a multiple subcategories, each subcategory containing no more than the predetermined maximum number of records; and
a delivering section for delivering a plurality of records, including records categorized into subcategories, to the requesting terminal device.

2. A system comprising a server according to claim 1 and at least one terminal device comprising:
a display section for displaying a selection screen identifying a plurality of record categories;
an input section for receiving a user selection of one of the identified record categories;
a category display control section for, if the specified category includes subcategories, causing the display section to display a selection screen for a plurality of subcategories included in the specified category to allow the user to specify a subcategory; and
a record display control section for, if the specified category includes no subcategory or that a subcategory including no subcategory has been specified, causing the display section to display a plurality of records included in the specified category or subcategory.

3. The system according to claim 2, wherein
the categorizing section of the server further categorizes each of the subcategories having more than the maximum number of records into a plurality of further subcategories; and
the category display control section of the terminal device causes, where the specified subcategory further includes subcategories, the display section to display a selection screen for a plurality of subcategories included in the specified subcategory.

4. The system according to claim 3,
wherein the terminal device further comprises: a storage section configured to store the maximum number of records that can be included in one category, the maximum number being predetermined according to the throughput of the terminal device and the amount of information that can be shown on the display section; and a request sending section for sending the stored maximum number to the server in association with a data delivery request; and
wherein the determining section of the server determines whether the number of records included in each category exceeds the maximum number received from the request sending section, in response to the data delivery request.

5. The system according to claim 4 wherein:
the storage section of the terminal device further stores a categorizing method for categorizing records included in one category into subcategories when the number of the records included in the one category exceeds the maximum number;
the request sending section of the terminal device further sends the categorizing method to the server in association with the data delivery request and the maximum number; and
the categorizing section of the server categorizes a plurality of records included in a category having more than the maximum number of records into a plurality of subcategories by the categorizing method received from the request sending section.

6. The system according to claim 5 wherein:
the storage section of the terminal device stores, as the categorizing method, a set of a record attribute used as a categorization factor and a condition that the records to be categorized into subcategories should satisfy for the attribute; and
the categorizing section of the server categorizes a plurality of records included in a category having more than the maximum number of records into a plurality of subcategories, depending on whether the attribute specified by the categorizing method satisfies the condition specified by the categorizing method.

7. The system according to claim 6 wherein:
the storage section of the terminal device stores a name generating method for generating the names of the respective subcategories from the name of a category to be categorized;
the categorizing section of the server generates the names of the subcategories after categorization by the name generating method; and
the category display control section of the terminal device causes the display section to display the generated names of the subcategories as a subcategory selection screen.

8. The system according to claim 5, wherein the server further comprises:
a cache for storing information indicating a structure of the categorized category in association with a set of the maximum number and the categorizing method every time the records are categorized into subcategories by the categorizing section; and
a cache searching section for searching the cache according to the set of the maximum number and the categorizing method in response to receiving the maximum number and the categorizing method from the request sending section,
wherein the set of the maximum number and the categorizing method received from the request transmitting section is detected, the delivering section reads a structure corresponding to the detected set and delivers the records categorized by the structure.

9. For use in a server, a method for delivering data to at least one terminal device, said method comprising the steps of:
storing data to be delivered in predetermined categories;
receiving a request from a terminal device for delivery of data included in one of the predetermined categories;
determining whether the number of records in the predetermined category exceeds a predetermined maximum number;
creating a plurality of subcategories for records in the predetermined category, each of said subcategories containing no more than the predetermined maximum number of records; and
delivering records in at least one of the created subcategories to the requesting terminal.

10. A method according to claim 9 wherein the step of receiving a request from a terminal device includes the further step of analyzing the request to determine whether the predetermined maximum number is specified as part of the request.

11. A method according to claim 9 wherein the step of creating a plurality of subcategories further comprises the steps of:
determining whether any initially created subcategory includes more than the predetermined maximum number of records;
for each initially created subcategory that is determined to include more than the predetermined maximum number of records, creating a plurality of further subcategories.

12. A method according to claim 11 wherein the step of creating a plurality of subcategories further comprises the steps of:
determining whether any initially created subcategory includes more than the predetermined maximum number of records;
for each initially created subcategory that is determined to include more than the predetermined maximum number of records, creating a plurality of further subcategories.

13. A method according to claim 9 further comprising the steps of:
caching information indicating a structure of a category in association with a maximum number and the categorization method used for assigning records to the category;
searching the cached information for matches between the stored maximum number and categorization method and the maximum number and categorization method specified in a received request for information;
retrieving for delivery any records assigned to a category associated with a matched maximum number and categorization method.

14. A computer program product for delivering data to one or more terminal devices comprising a computer usable medium embodying program instructions, said program instructions when loaded into and executed by a computer causing the computer to perform a method comprising the steps of:
storing data to be delivered in predetermined categories;
receiving a request from a terminal device for delivery of data included in one of the predetermined categories;
determining whether the number of records in the predetermined category exceeds a predetermined maximum number;
creating a plurality of subcategories for records in the predetermined category, each of said subcategories containing no more than the predetermined maximum number of records; and
delivering records in at least one of the created subcategories to the requesting terminal.

15. A computer program product according to claim 14 wherein the program instruction that results in the step of receiving a request from a terminal device includes a further program instruction for causing the further step of analyzing the request to determine whether the predetermined maximum number is specified as part of the request.

16. A computer program product according to claim 14 wherein the program instruction that results in the step of creating a plurality of subcategories further comprises program instructions that result in the steps of:
determining whether any initially created subcategory includes more than the predetermined maximum number of records; and
for each initially created subcategory that is determined to include more than the predetermined maximum number of records, creating a plurality of further subcategories.

17. A computer program product according to claim 14 further comprising program instructions for causing the computer to perform the additional steps of:
caching information indicating a structure of a category in association with a maximum number and the categorization method used for assigning records to the category;
searching the cached information for matches between the stored maximum number and categorization method and the maximum number and categorization method specified in a received request for information;
retrieving for delivery any records assigned to a category associated with a matched maximum number and categorization method.

18. A computer program product according to claim 15 further comprising program instructions for causing the computer to perform the additional steps of:
caching information indicating a structure of a category in association with a maximum number and the categorization method used for assigning records to the category;
searching the cached information for matches between the stored maximum number and categorization method and the maximum number and categorization method specified in a received request for information;
retrieving for delivery any records assigned to a category associated with a matched maximum number and categorization method.

19. A computer program product according to claim 16 further comprising program instructions for causing the computer to perform the additional steps of:
caching information indicating a structure of a category in association with a maximum number and the categorization method used for assigning records to the category;
searching the cached information for matches between the stored maximum number and categorization method and the maximum number and categorization method specified in a received request for information;
retrieving for delivery any records assigned to a category associated with a matched maximum number and categorization method.
